(19) United States
(12) Patent Application Publication
(10) Pub. No.: US 2007/0110923 A1
(43) Pub. Date: May 17, 2007

(54) LIQUID CRYSTAL DISPLAY PANEL, FABRICATING METHOD THEREOF AND SEALANT OF LIQUID CRYSTAL DISPLAY PANEL

(76) Inventors: Yu-Hsien Chen, Kaohsiung City (TW); Shih-Tsung Yang, Taipei County (TW); Kuo-Sheng Sun, Taoyuan City (TW); Huai-An Li, Taoyuan County (TW); Yu-Cheng Lo, Taipei City (TW); Sheng-Fa Liu, Hsinchu County (TW); Kun-Hong Chen, Taipei County (TW); Jyh-Hong Jaw, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,483

(22) Filed: Nov. 24, 2005

(30) Foreign Application Priority Data
Nov. 16, 2005 (TW) 94140228

(51) Int. Cl. C09K 19/00

(52) U.S. Cl. 428/1.5; 428/1.1

(57) ABSTRACT

A method of fabricating a liquid crystal display panel is provided. The method includes the following steps. First, a first substrate and a second substrate are provided, and an alignment film is respectively formed on the first and second substrate. Then, a sealant and a liquid crystal layer are formed between the first substrate and the second substrate, and the liquid crystal layer disposed between the first and second substrates is enclosed by the sealant. Wherein, the total ion concentration of the sealant is lower than 30 ppm with the concentration of Na⁺ lower than 10 ppm, the concentration of K⁺ lower than 5 ppm, the concentration of Mg⁺² lower than 5 ppm and the concentration of Ca⁺² lower than 5 ppm. Furthermore, a liquid crystal display panel and the sealant of a liquid crystal display panel are provided.

### CROSS-REFERENCE TO RELATED APPLICATION

This application claims the priority benefit of Taiwan application serial no. 94140228, filed on Nov. 16, 2005. All disclosure of the Taiwan application is incorporated herein by reference.

### BACKGROUND OF THE INVENTION

1. Field of the Invention

The present invention generally relates to a display panel. More particularly, the present invention relates to a liquid crystal display panel, a fabricating method thereof and the method of forming a sealant of the liquid crystal display panel.

2. Description of Related Art

The fast progress of semiconductor elements and human-computer display devices is advantageous for the development of the multimedia technologies. In various display devices, cathode ray tube (CRT) displays have monopolized the market for their excellent performance in displaying and economic advantages. However, in view of environmental protection, the CRT technology still has many problems; for example, a CRT is not power saving as it requires operating a terminal/monitor device individually. Thus, in the environmental considerations, a CRT is a waste in space and energy consumption, thereby incapable of meeting the demand of low power consumption and reduction in size. Therefore, liquid crystal display (LCD) devices having advantages of higher image quality, optimal space efficiency, low power consumption and non-radiation has become the main stream in the market.

A conventional liquid crystal display panel mainly comprises two substrates and a liquid crystal layer between two substrates. No matter in an active matrix liquid crystal display device or in a passive matrix liquid crystal display device, it is necessary to dispose alignment films on the two substrates. The main function of the alignment films is to align liquid crystal molecules, so as to twist the liquid crystal molecules between the two substrates. The fabrication process of the alignment films comprises the steps of forming an alignment material layer and patterning the alignment material layer. The method of patterning the alignment material layer is usually achieved by rubbing of cloth attached to a roller against the substrate, to align the alignment material layer and complete the fabrication of the alignment layer.

With the increased size of the substrate, the uniformity of the alignment by using the conventional roller is limited to that of the roller and cloth, static electricity and small particles, causing the alignment unstable. To solve the above-mentioned problem, non-contact alignment technology such as UV alignment, ion beam alignment and plasma alignment are developed to overcome these problems, wherein the ion beam alignment has the potential for mass production.

FIG. 1 is a schematic diagram showing the ion beam alignment. FIG. 2 is a schematic diagram showing the alignment film reacting with the sealant. Please refer to FIG. 1 and FIG. 2, an ion beam 50 is incident to the alignment material layer 120 on the substrate 110 at a specific angle θ to perform an alignment process on the alignment material layer 120 by ion bombardment. It should be noted that in the ion beam alignment technology, if the alignment layer 120 is made of polyimide, the structure of polyimide may break and become unstable during the ion bombardment. Thereby, the alignment material layer 120 is likely to react with the organic materials, such as the sealant 80 shown in FIG. 2, which will cause pollution. More specifically, after ions bombarding the alignment material layer 120, active radicals 122, likely to react with the ions 82 in the sealant 80, are generated on the surface of the alignment material layer 120. Therefore, it may cause generation of bright spots or dark spots as the liquid crystal display panel displays, and a part of the alignment film may be out of order, thereby influencing the display quality of the liquid crystal display panel.

To avoid the above-mentioned problem, diamond like carbon (DLC) is used as the alignment material layer in the ion beam alignment technology. If the alignment film is formed by way of the ion beam alignment technology, the DLC equipment is required, which will increases the cost. Besides, the ion beam alignment technology is performed under vacuum environment, which means that the DLC and ion bombardment equipments should be vacuum equipments. However, it is hard to maintain vacuum equipments and the activation is lower that would affect the production and increase the maintenance cost.

### SUMMARY OF THE INVENTION

A main purpose of the present invention is to provide a method of fabricating a liquid crystal display panel, so as to prevent active radicals on the surface of the alignment films from reacting with ions in the sealant, and the display quality of the liquid crystal display panel is improved as a result.

The second purpose of the present invention is to provide a method of forming a sealant of the liquid crystal display panel with a lower possibility of ions in the sealant reacting with active radicals on the surface of the alignment films of the liquid crystal display panel.

The third purpose of the present invention is to provide a liquid crystal display panel to reduce the possibility of active radicals on the surface of the alignment films reacting with ions in the sealant, and thereby the display quality of the liquid crystal display panel is improved.

In order to achieve the above purposes and others, a method of fabricating a liquid crystal display panel according to the present invention is provided with the following steps: providing a first substrate and a second substrate with an alignment film formed on the first and second substrates respectively; and forming a sealant and a liquid crystal layer between the first and second substrates, and the liquid crystal layer disposed between two substrates being enclosed by the sealant, wherein the total ion concentration of the sealant is lower than 30 ppm with the concentration of Na⁺ lower than 10 ppm, the concentration of K⁺ lower than 5 ppm, the concentration of Mg⁺² lower than 5 ppm and the concentration of Ca⁺² lower than 5 ppm.

According to one embodiment of the present invention, the method of forming the sealant and the liquid crystal layer between the first and second substrates comprises the following steps: forming the sealant on the first substrate; performing a one-drop-fill process to form the liquid crystal layer between the first substrate and the second substrate, wherein the liquid crystal layer is disposed within the sealant; and assembling the first substrate with the second substrate.

According to one embodiment of the present invention, the method of forming the sealant and the liquid crystal layer between the first and second substrates comprises the following steps: forming the sealant having a gap on the first substrate; assembling the first substrate with the second substrate; and performing a vacuum-injection process to inject liquid crystal molecules through the gap of the sealant to form the liquid crystal layer between the first substrate and the second substrate.

According to one embodiment of the present invention, after performing a vacuum-injection process, the method further includes a step of forming a sealing to cover the gap of the sealant with the total ion concentration of the sealing lower than 200 ppm, the concentration of Cl⁻ lower than 150 ppm, the concentration of Na⁺ lower than 10 ppm and the concentration of K⁺ lower than 10 ppm.

According to one embodiment of the present invention, the method of forming the alignment film comprises the following steps: forming an alignment material layer on the first and second substrates; and patterning the alignment material layer to form the alignment film.

According to one embodiment of the present invention, the method of forming the alignment films is an inkjet printing method.

According to one embodiment of the present invention, the method of forming the alignment films is a transfer printing method.

According to one embodiment of the present invention, the method of patterning the alignment films is an ion beam alignment method.

According to one embodiment of the present invention, the material of the alignment film comprises polyimide.

The present invention also provides a sealant of the liquid crystal display panel. The method comprises the following steps: providing a substrate with an alignment film formed thereon; and forming a sealant on the substrate, the sealant having total ion concentration lower than 30 ppm, concentration of Na⁺ lower than 10 ppm, concentration of K⁺ lower than 5 ppm, concentration of Mg⁺² lower than 5 ppm and concentration of Ca⁺² lower than 5 ppm.

The present invention further provides a liquid crystal display panel, which comprises a first substrate, a second substrate, a sealant and a liquid crystal layer. The first and second substrates have an alignment film respectively, and the sealant is disposed between the first and second substrates. The total ion concentration of the sealant is lower than 30 ppm with the concentration of Na⁺ lower than 10 ppm, the concentration of K⁺ lower than 5 ppm, the concentration of Mg⁺² lower than 5 ppm and the concentration of Ca⁺² lower than 5 ppm. Besides, the liquid crystal layer is disposed between the first substrate and the second substrate, and is disposed within the sealant.

According to one embodiment of the present invention, the liquid crystal display panel further comprises a sealing to cover a gap of the sealant with the total ion concentration of the sealing lower than 200 ppm, the concentration of Cl⁻ lower than 150 ppm, the concentration of Na⁺ lower than 10 ppm and the concentration of K⁺ lower than 10 ppm.

According to one embodiment of the present invention, the material of the alignment films comprises polyimide.

According to one embodiment of the present invention, the first substrate is an active device array substrate, and the second substrate is a color filter substrate.

According to one embodiment of the present invention, the first substrate is an active device array substrate having a color filter layer, and the second substrate is a glass substrate.

The present invention reduces the opportunity of active radicals on the surface of the alignment films reacting with ions in the sealant in the ion beam alignment process by controlling the total ion concentration of the sealant and the concentration of Na⁺, K⁺, Mg⁺² and Ca⁺² to enhance the display quality of the liquid crystal display panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing ion beam alignment.

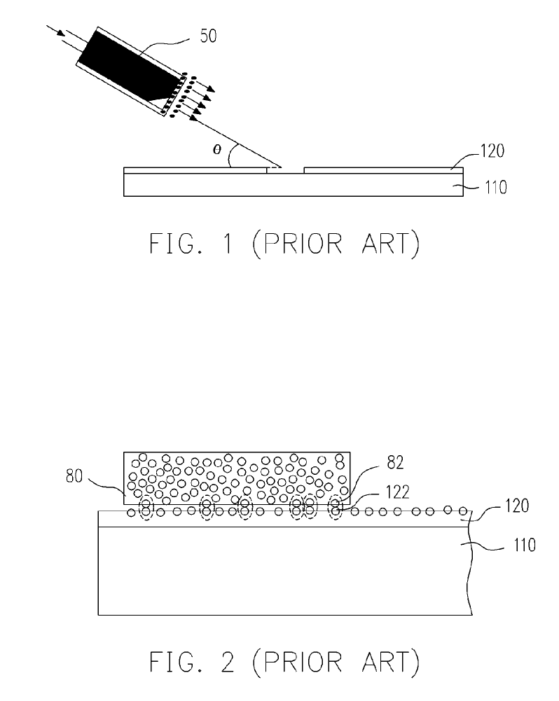

FIG. 2 is a schematic diagram showing the alignment film reacting with the sealant.

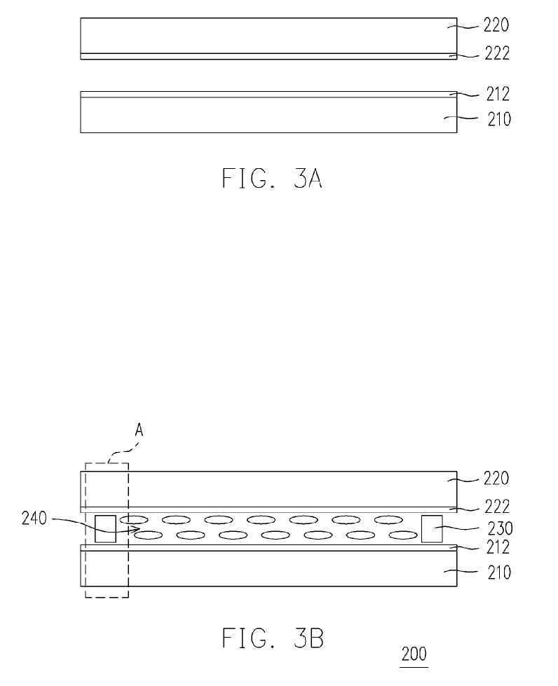

FIGS. 3A and 3B are schematic cross-sectional diagrams illustrating the process flow for fabricating a liquid crystal display panel according to one embodiment of the present invention.

FIG. 4 is a partially enlarged diagram of the area A shown in FIG. 3B.

FIGS. 5A to 5C are schematic cross-sectional diagrams illustrating the process flow for forming the sealant and the liquid crystal layer according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

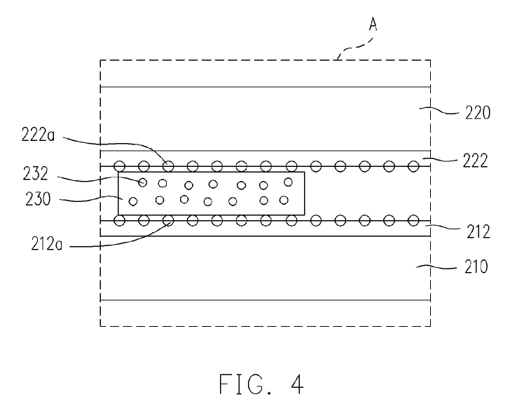

FIGS. 3A and 3B are schematic cross-sectional diagrams illustrating the process flow for fabricating a liquid crystal display panel according to one embodiment of the present invention. In FIG. 3A, the method of fabricating a liquid crystal display panel comprises the following steps. First, a first substrate 210 and a second substrate 220 are provided, and an alignment film 212, 222 is formed respectively on the first substrate 210 and the second substrate 220. In the present embodiment, the method of forming the alignment films 212, 222 comprises the steps of forming an alignment material layer (not shown) on the first and second substrate 210, 220 and then patterning the alignment material layer to form the alignment film 212, 222.

One of the first and second substrate 210, 220 is an active device array substrate with the other one being a color filter substrate. In another embodiment, one of the first and second substrate 210, 220 is an active device array substrate having a color filter film, and the other one is a glass substrate. The alignment material layer is made of polyimide. The alignment material layer is formed by the inkjet printing method. The polyimide liquid is sprayed on the first and second substrate 210, 220 by using an inkjet printing apparatus to form the alignment material layer. Moreover, in another embodiment, the polyimide liquid is coated on the first and second substrate 210, 220 to form the alignment material layer by the transfer printing method. Furthermore, the alignment material layer is patterned by the ion beam alignment method. Namely, the ion beam is incident onto the alignment material layer at a specific incident angle to form a desired alignment pattern thereon.

Then, in FIG. 3B, a sealant 230 and a liquid crystal layer 240 are formed between the first substrate 210 and the second substrate 220, and the sealant 230 encloses the liquid crystal layer 240 so as to keep the liquid crystal layer 240 disposed between the first and second substrate 210, 220. Specifically, the sealant 230 is formed on the first substrate 210, and then the one-drop-fill process is carried out to form the liquid crystal layer 240 between the first substrate 210 and the second substrate 220, and the liquid crystal layer 240 is disposed within the sealant 230. Then, the first substrate 210 is attached to the second substrate 220, and the sealant curing process is executed afterwards. The way of curing the sealant 230 depends on the material of the sealant 230. If the sealant 230 is a UV curable sealant, it is cured when exposed to ultraviolet light. If the sealant 230 is a thermosetting resin, the sealant 230 is cured when heated.

The liquid crystal display panel 200 is therefore completed by following the above-mentioned steps. The liquid crystal display panel 200 comprises the first substrate 210 having the alignment film 212, the second substrate 220 having the alignment film 222, the sealant 230 and the liquid crystal layer 240. The sealant 230 is disposed between the first and second substrates 210, 220, and the liquid crystal layer 240 is enclosed by the sealant 230 and disposed between the first and second substrates 210, 220.

Since the alignment material layer is patterned to form the alignment film 212, 222 by ion beam alignment technology, the active radicals, generated during the ion beam alignment process, on the surface of the alignment film 212, 222 may react with the ions in the sealant 230 to cause pollution. In order to avoid this problem, the total ion concentration of the sealant 230 is lower than 30 ppm with the concentration of Na⁺ lower than 10 ppm, the concentration of K⁺ lower than 5 ppm, the concentration of Mg⁺² lower than 5 ppm and the concentration of Ca⁺² lower than 5 ppm.

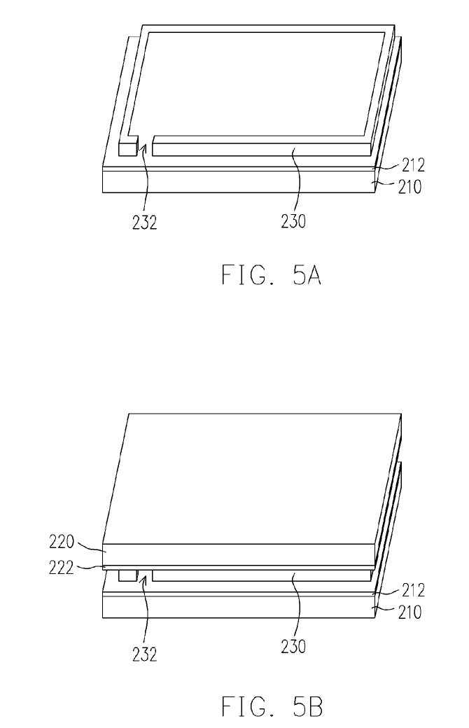

FIG. 4 is a partially enlarged diagram of the area A shown in FIG. 3B. In FIG. 4, since the sealant 230 in the present embodiment has a lower ion concentration, the possibility of reaction between the ions 232 in the sealant 230 and the active radicals 212a, 222a on the surface of the alignment film 212, 222 is lower. Therefore, the problem of generating bright spots or dark spots when the liquid crystal display panel 200 displays and causing a part of the alignment film out of order due to the reaction between the ions 232 and the active radicals 212a, 222a can be improved, and thereby the display quality of the liquid crystal display panel 200 is enhanced.

It should be noted that the liquid crystal cells are made by a non-contact process thoroughly during the cell process. Namely, the alignment material layer is formed by the inkjet printing method and patterned by the ion beam alignment technology, and the liquid crystal layer is formed by the one-drop-fill technology. Since the non-contact process has the advantages of non static electricity and non particles, the cost of equipments and spaces is reduced as well as the process yield is increased.

Besides the one-drop-fill process, the liquid crystal layer 240 can also be formed by the vacuum-injection process. Detailed description is illustrated below.

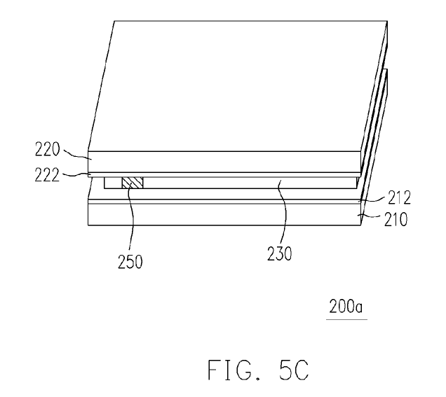

FIGS. 5A to 5C are schematic cross-sectional diagrams illustrating the process flow for forming the sealant and the liquid crystal layer according to another embodiment of the present invention. In FIG. 5A, the sealant 230 having a gap 232 is formed on the first substrate 210.

In FIG. 5B, the first and second substrates 210, 220 are assembled together, and the sealant 230 is cured. The method of curing the sealant 230 is the same as that described above. Then, the vacuum-injection process is executed to inject liquid crystal molecules through the gap 232 of the sealant 230 to form the liquid crystal layer (not shown) between the first substrate 210 and the second substrate 220, and within the sealant 230.

Next, in FIG. 5C, a sealing is formed to cover the gap 232 of the sealant 230 after the vacuum-injection process.

Compared to the method of forming the liquid crystal layer by the one-drop-fill process (as shown in FIG. 3B), the liquid crystal display panel 200a further comprises the sealing 250 used to cover the gap 232 of the sealant 230. In order to avoid the pollution caused by the active radicals on the surface of the alignment film 212, 222 reacting with the ions in the sealing 250, the present embodiment adopts the sealing 250 with the total ion concentration lower than 200 ppm, the concentration of Cl⁻ lower than 150 ppm, the concentration of Na⁺ lower than 10 ppm and the concentration of K⁺ lower than 10 ppm.

In summary, the present invention has the following advantages:

1. Since the total ion concentration and the concentrations of Na⁺, K⁺, Mg⁺² and Ca⁺² of the sealant are limited, the possibility of pollution caused by the active radicals on the surface of the alignment film reacting with the ions in the sealant during the ion beam alignment process is decreased, and thereby the display quality of the liquid crystal display panel is improved.

2. Since the liquid crystal cells are made by non-contact process thoroughly during the cell process so as to avoid the generation of static electricity and particles, the costs of equipments and spaces are decreased as well as the process yield is increased.

3. Since the total ion concentration and the concentrations of Na⁺, K⁺, Mg⁺² and Ca⁺² of the sealant are limited, the pollution caused by the active radicals on the surface of the alignment film reacting with the ions in the sealant during the ion beam alignment process is avoided, and thereby the display quality of the liquid crystal display panel is improved.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a liquid crystal display panel, comprising the following steps:
providing a first substrate and a second substrate with an alignment film formed on the first and second substrates respectively; and
forming a sealant and a liquid crystal layer between the first substrate and the second substrates, and the liquid crystal layer disposed between the first substrate and the second substrate being enclosed by the sealant, wherein the total ion concentration of the sealant is lower than 30 ppm with the concentration of Na⁺ lower than 10 ppm, the concentration of K⁺ lower than 5 ppm, the concentration of Mg⁺² lower than 5 ppm and the concentration of Ca⁺² lower than 5 ppm.

2. The method of fabricating a liquid crystal display panel according to claim 1, wherein the method of forming the sealant and the liquid crystal layer between the first and second substrates comprises the following steps:
forming the sealant on the first substrate;
performing an one-drop-fill process to form the liquid crystal layer between the first substrate and the second substrate, and within the sealant; and
assembling the first substrate with the second substrate.

3. The method of fabricating a liquid crystal display panel according to claim 1, wherein the method of forming the sealant and the liquid crystal layer between the first and second substrates comprises the following steps:
forming the sealant having a gap on the first substrate;
assembling the first substrate with the second substrate; and
performing a vacuum-injection process to inject liquid crystal molecules through the gap of the sealant to form the liquid crystal layer between the first substrate and the second substrate.

4. The method of fabricating a liquid crystal display panel according to claim 3, wherein after performing the vacuum-injection process, the method further comprises a step of forming a sealing to cover the gap of the sealant with the total ion concentration of the sealing lower than 200 ppm, the concentration of Cl⁻ lower than 150 ppm, the concentration of Na⁺ lower than 10 ppm and the concentration of K⁺ lower than 10 ppm.

5. The method of fabricating a liquid crystal display panel according to claim 1, wherein the method of forming each alignment film comprises the following steps:
forming an alignment material layer on the first and second substrates; and
patterning the alignment material layer to form the alignment film.

6. The method of fabricating a liquid crystal display panel according to claim 5, wherein the method of forming the alignment film is an inkjet printing method.

7. The method of fabricating a liquid crystal display panel according to claim 5, wherein the method of forming the alignment film is a transfer printing method.

8. The method of fabricating a liquid crystal display panel according to claim 5, wherein the method of patterning the alignment material layer comprises an ion beam alignment method.

9. The method of fabricating a liquid crystal display panel according to claim 1, wherein the material of the alignment film comprises polyimide.

10. A sealant of a liquid crystal display panel, the sealant having total ion concentration lower than 30 ppm, concentration of Na⁺ lower than 10 ppm, concentration of K⁺ lower than 5 ppm, concentration of Mg⁺² lower than 5 ppm and concentration of Ca⁺² lower than 5 ppm.

11. A liquid crystal display panel, comprising:
a first substrate;
a second substrate, wherein each of the first substrate and the second substrate comprises an alignment film respectively;
a sealant, disposed between the first substrate and the second substrate, with total ion concentration lower than 30 ppm, concentration of Na⁺ lower than 10 ppm, concentration of K⁺ lower than 5 ppm, concentration of Mg⁺² lower than 5 ppm and concentration of Ca⁺² lower than 5 ppm; and
a liquid crystal layer disposed between the first and second substrates and within the sealant.

12. The liquid crystal display panel according to claim 11, further comprising a sealing to cover a gap of the sealant with the total ion concentration of the sealing lower than 200 ppm, the concentration of Cl⁻ lower than 150 ppm, the concentration of Na⁺ lower than 10 ppm and the concentration of K⁺ lower than 10 ppm.

13. The liquid crystal display panel according to claim 11, wherein the material of the alignment film comprises polyimide.

14. The liquid crystal display panel according to claim 11, wherein the first substrate is an active device array substrate, and the second substrate is a color filter substrate.

15. The liquid crystal display panel according to claim 11, wherein the first substrate is an active device array substrate having a color filter layer, and the second substrate is a glass substrate.
